(19) United States
(12) Patent Application Publication
(10) Pub. No.: US 2021/0094124 A1
(43) Pub. Date: Apr. 1, 2021

(54) MANUFACTURING METHOD OF COMPONENT

(71) Applicant: FUTABA INDUSTRIAL CO., LTD., Aichi (JP)

(72) Inventor: Shinya AZUCHI, Aichi (JP)

(21) Appl. No.: 17/018,228

(22) Filed: Sep. 11, 2020

(30) Foreign Application Priority Data
Oct. 1, 2019 (JP) 2019-181288

(51) Int. Cl. B23K 26/24; B23K 26/06; B23K 26/08; B23K 26/244

(52) U.S. Cl. CPC B23K 26/24; B23K 26/0626; B23K 2101/006; B23K 26/244; B23K 26/08

(57) ABSTRACT

A manufacturing method of a component includes a method for welding base materials with each other by laser welding, in which welding is performed by irradiating a laser beam along a welding line. The manufacturing method of a component includes, before starting the welding along the welding line, increasing an output power of the laser beam, while repeatedly moving an irradiation position of the laser beam in a neighborhood of a start point of the welding line, repeatedly moving the irradiation position of the laser beam at least between a first point and a second point. The first point is the start point. The second point is different from the first point.

### CROSS-REFERENCE TO RELATED APPLICATIONS

The present application claims the benefit of Japanese Patent Application No. 2019-181288 filed on Oct. 1, 2019 with the Japan Patent Office, the entire disclosure of which is incorporated herein by reference.

### BACKGROUND

The present disclosure relates to a manufacturing method of a component by laser welding.

In laser welding, the higher an output power of a laser beam with which a base material is irradiated is, the more spatter tends to be generated. The spatter means a molten material scattered in a surrounding area from molten portion of the base material, of which a surface temperature locally becomes high when the base material is irradiated with the laser beam with high energy density. If the scattered molten material is stuck to the base material or the like as a foreign substance, it may reduce a quality of a component obtained by the laser welding.

As a method for reducing generation of spatter, Japanese Unexamined Patent Application Publication No. 2017-164811 describes that, at a start position of welding, irradiation of a laser beam is started with its output power at which spatter is not generated, and thereafter, the output power of the laser beam is gradually increased with the laser beam not being scanned so as to fall within a given range of penetration depth.

### SUMMARY

However, the method described in Japanese Unexamined Patent Application Publication No. 2017-164811 is predicated on slow increase in the output power of the laser beam so as not to generate spatter. Accordingly, this does not satisfy needs for increasing to a high output power of the laser beam in a short time to reduce cycle time in a welding step.

One aspect of the present disclosure provides a manufacturing method of a component by laser welding, making it possible to increase an output power of a laser beam in a short time while reducing generation of spatter.

One aspect of the present disclosure is a manufacturing method of a component comprising welding base materials with each other by laser welding, in which welding is performed by irradiating a laser beam along a welding line. Further, the manufacturing method of a component comprises, before starting the welding along the welding line, increasing an output power of the laser beam, while repeatedly moving an irradiation position of the laser beam in a neighborhood of a start point of the welding line, repeatedly moving the irradiation position of the laser beam at least between a first point and a second point. The first point is the start point. The second point is different from the first point.

With this configuration, the output power of the laser beam can be increased in a short time while generation of spatter can be reduced.

In one aspect of the present disclosure, the manufacturing method of a component may comprise: before starting the welding along the welding line, forming an initial molten pool at the start point by increasing the output power of the laser beam, while repeatedly moving the irradiation position of the laser beam in the neighborhood of the start point, repeatedly moving the irradiation position of the laser beam at least between the first point and the second point; and irradiating the laser beam along the welding line, from the start point where the initial molten pool is formed.

In one aspect of the present disclosure, the manufacturing method may comprise, before starting the welding along the welding line, increasing the output power of the laser beam to a target output power for the welding along the welding line, while repeatedly moving the irradiation position of the laser beam in the neighborhood of the start point, repeatedly moving the irradiation position of the laser beam at least between the first point and the second point.

In one aspect of the present disclosure, an irradiation spot of the laser beam in the second point may overlap at least part of an irradiation spot of the laser beam in the first point. With this configuration, a desired penetration depth can be more easily achieved.

In one aspect of the present disclosure, the irradiation position of the laser beam may be moved so as to go and return between the first point and the second point.

In one aspect of the present disclosure, a straight line passing through the first point and the second point may intersect with a tangent line of the welding line at the first point. With this configuration, a molten material easily flows from the initial molten pool to the welding line, thereby improving welding quality.

In one aspect of the present disclosure, the straight line passing through the first point and the second point may be orthogonal to the tangent line of the welding line at the first point. With this configuration, the molten material flows more easily from the initial molten pool to the welding line.

In one aspect of the present disclosure, the laser beam may be a fiber laser beam. Since the fiber laser beam with high energy density tends to generate spatter, the above-described manufacturing method of a component by the laser welding is more advantageous especially in methods using the fiber laser beam as a laser beam.

### BRIEF DESCRIPTION OF THE DRAWINGS

An example embodiment of the present disclosure will be described hereinafter by way of example with reference to the accompanying drawings, in which:

FIG. 1A is a diagram explaining a manufacturing method of a component by laser welding, as viewed from a side surface of the component;

FIG. 1B is a diagram explaining a manufacturing method of a component by laser welding, as viewed from a surface of a base material;

FIG. 2A is a diagram explaining a forming method of an initial molten pool;

FIG. 2B is a diagram explaining the forming method of an initial molten pool;

FIG. 2C is a diagram explaining the forming method of an initial molten pool;

FIG. 2D is a diagram explaining the forming method of an initial molten pool;

FIG. 2E is a diagram explaining the forming method of an initial molten pool;

FIG. 3 is a diagram explaining a manner of setting an initial output power of a laser beam;

FIG. 4A is a diagram illustrating a modified example of a manner of increasing an output power of a laser beam;

FIG. 4B is a diagram illustrating a modified example of a manner of increasing an output power of a laser beam;

FIG. 5A is a diagram illustrating a modified example of how a laser beam goes and returns;

FIG. 5B is a diagram illustrating a modified example of how a laser beam goes and returns; and

FIG. 5C is a diagram illustrating a modified example of how a laser beam goes and returns.

### DETAILED DESCRIPTION OF EXEMPLARY EMBODIMENTS

[1. Manufacturing Method of Component]

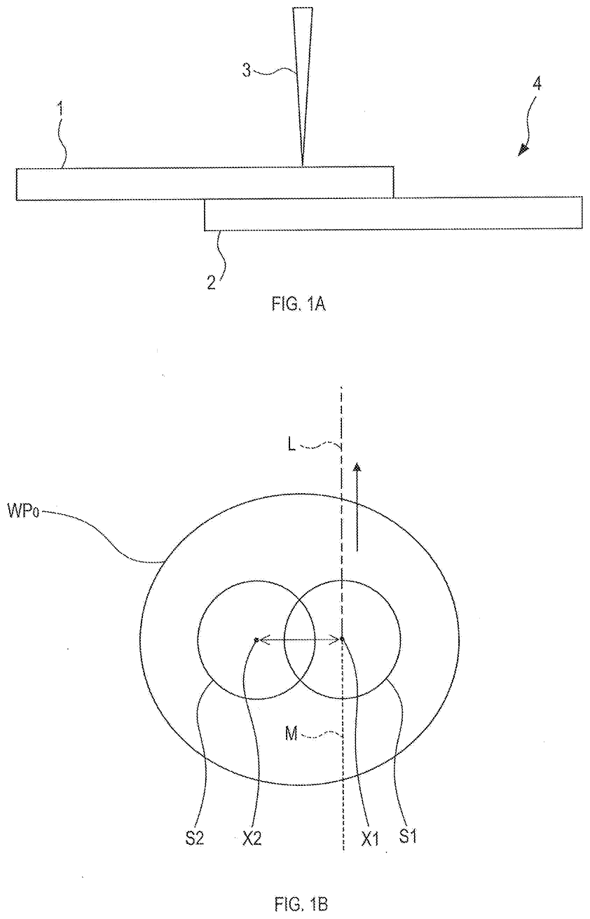

In a manufacturing method of a component, the component is manufactured by two or more base materials, which are welded with each other through laser welding. Specifically, as shown in FIG. 1A, two flat base materials 1 and 2 are overlapped with each other, and irradiation of a laser beam 3 directs the overlapped base materials 1 and 2. This makes each surface of the base materials 1 and 2 welded, thereby manufacturing an automobile component 4 including in part an overlapping structure of the two base materials 1 and 2. As one example of the base materials 1 and 2, stainless steel is used.

As shown in FIG. 1B, the laser welding is performed by irradiation of the laser beam along a welding line L. Specifically, the laser beam is scanned from a start point X1 of the welding line L so as to pass on the welding line L. The welding line L means a line planned to be welded, and the start point X1 of the welding line L means a start point where the welding is started on the welding line L. As one example, the welding line L is shaped in a straight line extending from the start point X1.

Further, as one example of the laser beam, a fiber laser beam is used.

At first, before the welding along the welding line L is started, an initial molten pool WP₀ is formed at the start point X1. The molten pool means a portion of a base material, which is molten by irradiation of the laser beam, and the initial molten pool WP₀ means a molten pool formed at the start point X1. A forming method of the initial molten pool WP₀ will be described later.

Next, the laser beam with a target output power P_{T} is irradiated along the welding line L, from the start point X1 where the initial molten pool WP₀ is formed. Specifically, the laser beam is irradiated on the welding line L, directing a stop point, which is not shown, of the welding line L from the start point X1.

To form the initial molten pool WP₀, an output power P of the laser beam is increased stepwise to the target output power P_{T} from an initial output power P₀, which is lower than the target output power P_{T}, while an irradiation position of the laser beam is moved in a neighborhood of the start point X1 so as to go and return between two points of the start point X1 (hereinafter also “a first point X1”) and a second point X2. The second point X2 is different from the first point X1. Specifically, the initial molten pool WP₀ is formed by the forming method described below.

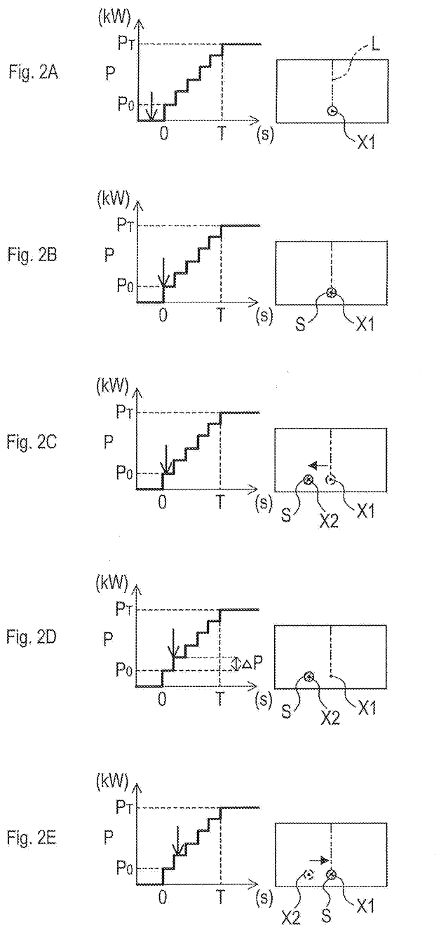

First, a position of a welding head on which a radiator of the laser beam is mounted is set such that irradiation with the laser beam is applied to the first point X1 as shown in FIG. 2A. At this stage, the irradiation with the laser beam on the base material is still not started. A graph in FIG. 2A shows a relationship between the output power P of the laser beam and time, and an arrow in the graph indicates a current stage in the forming method of the initial molten pool WP₀. The same applies to subsequent figures from FIGS. 2B to 2E.

Next, as shown in FIG. 2B, the output power of the laser beam is increased to the initial output power P₀, and then the irradiation with the laser beam on the base material is started. At this time, the laser beam is irradiated to the first point X1 as shown by an irradiation spot S in FIG. 2B.

Next, as shown in FIG. 2C, with the output power P of the laser beam being maintained at the initial output power P₀, the irradiation position of the laser beam is moved from the first point X1 to the second point X2.

The second point X2 is a point in the neighborhood of the start point X1 (the first point X1), or more specifically, a point positioned at a short distance from the start point X1 so as to form the initial molten pool WP₀ into a desired dimension in the start point X1. Here, the dimension of the initial molten pool WP₀ means both a surface area and a penetration depth of the base material of the initial molten pool WP₀. The penetration depth means a depth of the molten pool to be formed on the base material, from a top surface of the base material in an irradiation direction of the laser beam.

Further, as shown in FIG. 1B, the second point X2 is positioned not on an extending line M extending from the welding line L, but away from the extending line M. Thus, a straight line passing through the first point X1 and the second point X2 intersects with the welding line L and the extending line M, or equivalently, with a tangent line of the welding line L at the first point X1. As one example, the straight line passing through the first point X1 and the second point X2 is orthogonal to the welding line L and the extending line M.

Next, as shown in FIG. 2D, with the irradiation position of the laser beam being at the second point X2, the output power P of the laser beam is increased by a specified output pitch ΔP with respect to the initial output power P₀.

Next, as shown in FIG. 2E, with the output power P of the laser beam being maintained at the initial output power P₀+ΔP, the irradiation position of the laser beam is moved from the second point X2 to the first point X1.

The movement between the two points of the first point X1 and the second point X2, and the increase in the output power P of the laser beam by the output pitch ΔP are repeated until the output power P reaches the aforementioned target output power P_{T}. When the output power P reaches the target output power P_{T}, the desired initial molten pool WP₀ is formed at the start point X1 (the first point X1), and from there the welding along the welding line L can be started.

The aforementioned initial output power P₀, a moving distance ΔX between the first point X1 and the second point X2, and the number n of the movement between the first point X1 and the second point X2 may be changed depending on the aforementioned target output power P_{T}, the dimension of the initial molten pool WP₀ intended to be formed, a target time T when the output power of the laser beam at the start of irradiation reaches the target output power P_{T}, a material type and thickness of the base material, a type of laser beam, and the like.

One example of a manner of setting the initial output power P₀, the moving distance ΔX, and the number n of the movement will be described below.

First, as a broad target, it is set that a desired penetration depth of the initial molten pool WP₀ and a desired value of the target output power P_{T} are obtained at the target time T.

Next, the moving distance ΔX is set. Here, if the moving distance ΔX is too great, it becomes difficult to obtain the desired penetration depth within the target time T.

As one example, it is preferable that the moving distance ΔX is equal to or smaller than a beam diameter of the laser beam. The beam diameter means a beam diameter of the laser beam on the base material. When the moving distance ΔX is equal or smaller than the beam diameter, as shown in FIG. 1B, an irradiation spot S1 of the laser beam in the first point X1 and an irradiation spot S2 of the laser beam in the second point X2 are partially overlapped with each other, thereby easily achieving the desired penetration depth. A rough approximation is that the moving distance ΔX is, for example, about from some hundred nanometers to some millimeters with respect to the beam diameter of some micrometers to some ten millimeters.

The number n of the movement is not limited to a specific number; however, for example, a moving speed V_{X} between the first point X1 and the second point X2 may be set equivalently to a welding speed, that is, a moving speed V_{L} of the laser beam when the welding is performed along the welding line L. In other words, if the moving speed V_{X} is determined, a product of the moving speed V_{X} and the target time T is divided by the moving distance ΔX, which naturally leads to the number n of the movement. A rough approximation is that the number of the movement is, for example, about from some tens to some thousands.

The initial output power P₀ may be appropriately set to a value less than the target output power P_{T}. However, if the initial output power P₀ is too high, more spatter tends to be generated. In contrast, if the initial output power P₀ is too low, it becomes difficult to obtain the desired penetration depth within the target time T. Thus, it is preferable that the initial output power P₀ is set to an output power at which spatter is not generated, specifically, an output power at which spatter is not generated when the forming method of the initial molten pool WP₀ as described above is performed.

An appropriate vale of the initial output power P₀ can be found by determining whether the desired penetration depth can be obtained and whether spatter is generated, when the forming method of the initial molten pool WP₀ as described above is actually performed under conditions of the target time T, the moving distance ΔX, the number n of the movement, and the like as set above.

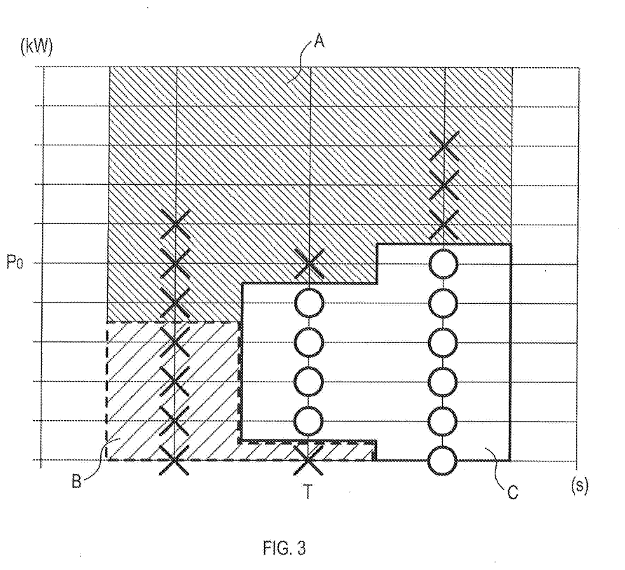

For example, the target time T is set within a certain range. FIG. 3 shows test results, in which the initial output power P₀ is variously changed under the aforementioned setting conditions. In the tests, whether the desired penetration depth is achieved is determined by whether the molten pool penetrates through bottom surfaces of the base materials. As shown in FIG. 3, in an area A where the initial output power P₀ was relatively high, spatter was generated. In an area B where the initial output power P₀ was relatively low but the target time T was relatively short, no penetration occurred. In an area C where the initial output power P₀ was relatively low and the target time T was relatively longer, spatter was not generated and the penetration occurred. Among such appropriate values in the area C, a relatively low value can be selected, to be on the safe side, and set as the initial output power P₀.

In accordance with an approach as described above, the initial output power P₀, the moving distance ΔX, and the number n of the movement can be set. If the number n of the movement and the initial output power P₀ are set, a value obtained by subtracting the initial output power P₀ from the target output power P_{T} is divided by the number n of the movement, which naturally leads to the aforementioned output power pitch ΔP.

[2. Effects]

According to the above-detailed embodiment, the following effects can be obtained.

(2a) In the embodiment, before the welding along the welding line L is started, the output power of the laser beam is increased, while the irradiation position of the laser beam is repeatedly moved in the neighborhood of the start point X1 (the first point X1) of the welding line L, repeatedly moved at least between the first point X1 and the second point X2. The second point X2 is different from the first point X1. With this configuration, heat concentration at the start point X1 can be avoided, as compared to a case where the output power of the laser beam is sharply increased from the start point X1 without any movement of the laser beam. As a result, a sharp increase in temperature in the molten portion can be avoided. This makes it possible to avoid rapid vaporization of the molten material, thereby reducing generation of spatter. Further, the output power of the laser beam can be increased in a shorter time, as compared to a case where the output of the laser beam is slowly increased from the start point X1 without any movement of the laser beam in order to reduce generation of spatter.

(2b) In the embodiment, the irradiation spot S2 of the laser beam in the second point X2 overlaps at least part of the irradiation spot S1 of the laser beam in the first point X1. With this configuration, the desired penetration depth can be more easily achieved.

(2c) In the embodiment, the straight line passing through the first point X1 and the second point X2 intersects with the welding line L and the extending line M. In other words, the straight line passing through the first point X1 and the second point X2 intersects with the tangent line of the welding line L at the first point X1. With this configuration, the initial molten pool WP₀ is formed closer to the welding line L, as compared to a case where the second point X2 is positioned on the extending line M extending from the welding line L, in other words, a case where the straight line passing through the first point X1 and the second point X2 does not intersect with the tangent line of the welding line L at the first point X1. This enables the molten material to easily flow from the initial molten pool WP₀ to the welding line L, thereby improving welding quality. In the embodiment, particularly, since the straight line passing through the first point X1 and the second point X2 is orthogonal to the welding line L and the extending line M, the molten material flows more easily from the initial molten pool WP₀ to the welding line L.

(2d) In the embodiment, the laser beam is a fiber laser beam. The fiber laser beam has better light collecting performance than other types of laser beams used in welding, such as YAG laser, and further allows for a high laser beam energy density on welding spots. Accordingly, more spatter tends to be generated in the welding using the fiber laser beam as a laser beam, than using other types of laser beams. The above-described manufacturing method of a component by the laser welding in the embodiment enables generation of spatter to be reduced, and thus, this method is more advantageous especially in methods using fiber laser beams as a laser beam.

### 3. Other Embodiments

It is understood that the present disclosure is not limited to the embodiment and can take various forms.

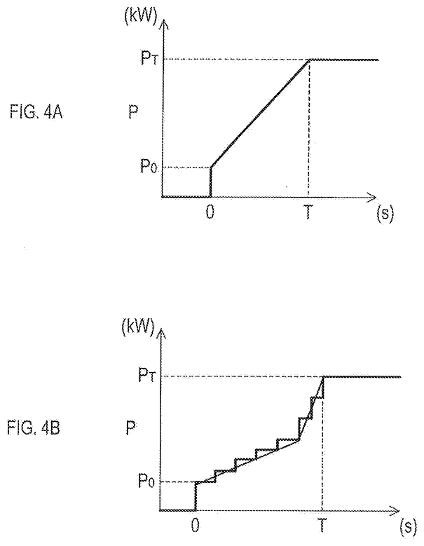

(3a) In the embodiment, the output power of the laser beam is increased stepwise, but a way of increasing the output power is not limited. For example, as shown in FIG. 4A, the output power may be linearly increased. Further, in the embodiment, the output power of the laser beam is increased at constant output pitches, but such output pitches may vary. For example, as shown in FIG. 4B, a step of increasing the output power of the laser beam may be divided into two steps, in which the output pitch is smaller in the first step than in the second step.

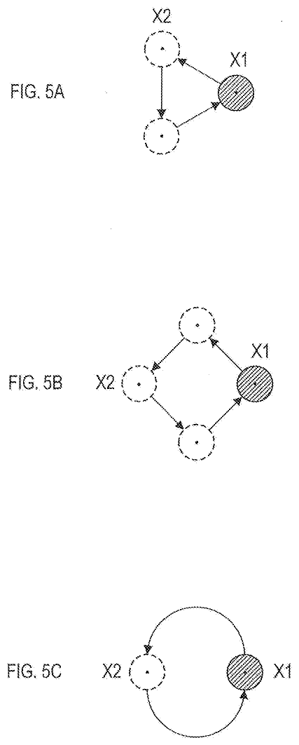

(3b) In the embodiment, the irradiation position of the laser beam is moved so as to go and return between the two points of the first point X1 and the second point X2, but a manner of the movement of the irradiation position of the laser beam is not limited. For example, the laser beam may be moved between three points as shown in FIG. 5A, or between four points as shown in FIG. 5B. Alternatively, as shown in FIG. 5C, the laser beam may be moved such that it starts at the first point X1, which is the start point of the welding line L, moves along an arc, passes through the second point X2, and returns to the first point X1. In the case of FIG. 5C, the laser beam can be moved smoothly, and thus the molten material from the initial molten pool WP₀ is less likely to scatter than in the cases of FIGS. 5A and 5B. Here, the second point X2 in these cases means the farthest point of a path where the irradiation position of the laser beam passes.

(3c) In the embodiment, the second point X2 is positioned such that the straight line passing through the first point X1 and the second point X2 is orthogonal to the welding line L and the extending line M, but the position of the second point X2 is not limited. For example, the second point X2 may be positioned on the extending line M extending from the welding line L, or may be positioned such that the straight line passing through the first point X1 and the second point X2 intersects with the welding line L and the extending line M at a given angle.

(3d) In the embodiment, the welding line L is formed in a straight line, but a shape of the welding line L is not limited. For example, the welding line L may be curved. It should be noted that, since the welding line L in the embodiment is straight, the tangent line of the welding line L at the first point X1 corresponds to the welding line L and the extending line M.

(3e) The output power of the laser beam irradiated along the welding line L need not be constant on the welding line L, and the laser beam may be irradiated on the welding line L while changing its output power. The aforementioned target output power P_{T} means a target output power at the start of welding.

(3f) In the embodiment, the movement of the irradiation position of the laser beam is started from the first point X1 to form the initial molten pool WP₀, but a start positon where the laser beam starts to move its irradiation position is not limited. For example, the movement of the irradiation position of the laser beam may be started from the aforementioned second point X2.

(3g) In the embodiment, the moving speed V_{X} between the first point X1 and the second point X2 is equivalent to welding speed V_{L}, but may be different from each other.

(3h) In the embodiment, the laser beam is a fiber laser beam, but a type of the laser beam is not limited. For example, the laser beams may be a CO₂ laser beam, a YAG laser beam, a semiconductor laser beam, and an LD excitation solid laser beam (including a disk laser beam).

(3i) In the embodiment, the base material is stainless steel, but a material type of the base material is not limited. For example, such material types of the base material may include not only the aforementioned stainless steel, but also aluminized steel, copper coated steel, iron steel, aluminum, aluminum alloy, copper, and copper alloy.

(3j) In the embodiment, surfaces of the overlapped base materials are welded with each other by penetration welding, thereby forming a so-called lap joint. However, a structure formed by the laser welding is not limited. For example, such structures formed by the laser welding may include a butt joint, a corner joint, an edge joint, a tee joint by the penetration welding, a tee joint by fillet welding, and a lap joint by the fillet welding. Further, in the embodiment, the welding is performed by irradiation of the laser beam perpendicular to the base material, but an angle, or the like, at which the laser beam is irradiated, is not limited. The above-described method in the embodiment may apply to various welding methods.

(3k) In the embodiment, an automobile component 4 is manufactured. The automobile component 4 to be manufactured may be, for example, an instrument panel reinforcement, or other components. Further, a component to be manufactured is not limited to the automobile component 4, but may be, for example, a component for consumer electronics, or the like.

(3l) The function(s) performed by a single element in the aforementioned embodiments may be performed by multiple elements. The function(s) performed by multiple elements may be performed by a single element. Part of the configuration of the aforementioned embodiments may be omitted. At least part of the configuration of the aforementioned embodiments may be added to or replaced by the configuration of the aforementioned other embodiments.

What is claimed is:

1. A manufacturing method of a component, the method comprising: welding base materials with each other by laser welding, in which welding is performed by irradiating a laser beam along a welding line,
the method further comprising, before starting the welding along the welding line, increasing an output power of the laser beam, while repeatedly moving an irradiation position of the laser beam in a neighborhood of a start point of the welding line, repeatedly moving the irradiation position of the laser beam at least between a first point and a second point, the first point being the start point, the second point being different from the first point.

2. The manufacturing method of a component according to claim 1,
wherein the method comprises:
before starting the welding along the welding line, forming an initial molten pool at the start point by increasing the output power of the laser beam, while repeatedly moving the irradiation position of the laser beam in the neighborhood of the start point, repeatedly moving the irradiation position of the laser beam at least between the first point and the second point; and
irradiating the laser beam along the welding line, from the start point where the initial molten pool is formed.

3. The manufacturing method of a component according to claim 1,
wherein the method comprises, before starting the welding along the welding line, increasing the output power of the laser beam to a target output power for the welding along the welding line, while repeatedly moving the irradiation position of the laser beam in the neighborhood of the start point, repeatedly moving the irradiation position of the laser beam at least between the first point and the second point.

4. The manufacturing method of a component according to claim 1,
wherein an irradiation spot of the laser beam in the second point overlaps at least part of an irradiation spot of the laser beam in the first point.

5. The manufacturing method of a component according to claim 1,
wherein the irradiation position of the laser beam is moved so as to go and return between two points of the first point and the second point.

6. The manufacturing method of a component according to claim 1,
wherein a straight line passing through the first point and the second point intersects with a tangent line of the welding line at the first point.

7. The manufacturing method of a component according to claim 1,
wherein a straight line passing through the first point and the second point is orthogonal to a tangent line of the welding line at the first point.

8. The manufacturing method of a component according to claim 1,
wherein the laser beam is a fiber laser beam.
